(19) United States
(12) Patent Application Publication
(10) Pub. No.: US 2026/0326082 A1
(43) Pub. Date: Oct. 22, 2026

(54) Graft Copolymers for Carbon Dioxide Capture from Gaseous and Aqueous Environments

(71) Applicant: TDA Research, Inc., Golden, CO (US)

(72) Inventor: Robin Cywar, Arvada, CO (US)

(73) Assignee: TDA Research, Inc., Golden, CO (US)

(21) Appl. No.: 19/652,663

(22) Filed: Apr. 20, 2026

Related U.S. Application Data
(60) Provisional application No. 63/792,134, filed on Apr. 21, 2025.

(51) Int. Cl. B01J 20/26; B01D 53/62; B01D 53/82; C02F 1/20; C02F 1/28; C02F 101/10; C02F 103/08; C08G 81/00; C08G 81/02

(52) U.S. Cl. CPC B01J 20/264; B01D 53/62; B01D 53/82; C02F 1/20; C02F 1/285; C08G 81/00; C08G 81/024; B01D 2253/202; B01D 2253/306; B01D 2253/311; B01D 2257/504; B01D 2258/06; C02F 2101/10; C02F 2103/08

(57) ABSTRACT

A grafted copolymer sorbent for CO₂ capture in gaseous and aqueous environments, formed using a grafting-from (ring-opening polymerization) technique. The sorbent is characterized by a porous support resin, a surface area of 25-250 m²/g, a nitrogen content of 5-30% by weight, a pore volume of 0.25-0.7 cm³/g, and its being formed by a grafting-from technique. A method for CO₂ capture from aqueous environments, including freshwater and ocean water, comprising contacting a water stream with a grafted-from sorbent. The sorbent has higher CO₂ uptake efficiency than grafted-to sorbents. A method for CO₂ capture from gaseous environments, comprising: providing the sorbent, wherein the sorbent is formed by the steps comprising: providing a support resin and cyclic imino ether-containing monomer compound and, grafting the cyclic imino ether-containing monomer compound off the support resin using a grafting-from technique; and contacting a gaseous stream containing CO₂ to be removed with the support.

### RELATED APPLICATIONS

The present application claims the benefit of provisional application No. 63/792,134 filed Apr. 21, 2025, which is incorporated by reference herein.

### STATEMENT OF GOVERNMENT INTEREST

This invention was made in part using U.S. government funding under contracts DE-SC0022687, DE-FE0032261, and DE-FE0032260 awarded by the Department of Energy (DOE). The government has certain rights in this invention.

### BACKGROUND

Carbon dioxide (CO₂) capture is a vital process for offsetting industrial emissions and reducing atmospheric CO₂ levels to combat global warming, as well as to control indoor atmospheres. Carbon capture has historically been implemented in point-source environments, where ≥4% CO₂, and is currently being developed and deployed for direct air capture (“DAC”). Oceans have also absorbed a vast quantity of anthropogenic CO₂, leading to a decrease in the pH of surface water. Ocean acidification occurs due to the formation of carbonic acid when CO₂ reacts with water. The ocean is buffered with a complex system based on dissolved CO₂ gas, carbonic acid, and bicarbonate and carbonate ions.

Solid carbon capture sorbents are commonly based on coating an active phase material onto a high surface area, porous support (e.g. fumed silica). The active phase is commonly organic polyalkyleneimines of low or high molecular weights. Humidity or steam may be present during typical process conditions, which assist with CO₂ binding and sorbent stability. Water vapor can also cause loss of active phase due to water solubility, while application of vacuum can cause volatilization for low molecular weight species. Higher molecular weight polyethyleneimine (“PEI”) polymers contain amine groups spaced by two carbon atoms and exhibit a branched (“BPEI”) or linear (“LPEI”) structure, depending on the method of preparation.

### SUMMARY

In polymer chemistry, grafted copolymers can be formed by grafting-from or grafting-to techniques to attach repeating side chains, also known as branches, to active sites on a resin backbone. Grafting-from involves polymerizing the side chains directly from the active sites, whereas grafting-to involves attaching pre-made side chains to the backbone via a coupling reaction. The grafted-from sorbents described herein allow significantly increased CO₂ uptake in DAC and direct ocean capture (“DOC”) applications, meaning CO₂ capture from gaseous and aqueous environments. The sorbents described herein may utilize structures outside of the traditional carbon capture field with amine attachments that do not migrate during the CO₂ capture process.

The synthesis of the sorbents may use specific grafted-from techniques, rather than grafting-to techniques to form the sorbent using the same support resin and structural repeat units. Using a grafted-from technique may result in differences in the number of repeating units attached to the successful graft initiation points, the amount of reacted versus unreacted initiation sites, and whether the graft point contains secondary or tertiary amines compared to the grafted-to sorbents. The grafted-to sorbents may have inferior carbon capture activity. The present disclosure teaches a sorbent and method of making a sorbent that tethers imine-containing compounds to a support resin, for example a polystyrene-based support, such that it does not migrate during carbon capture. The support may be porous or highly porous. The support resin may be chloromethylated polystyrene.

The present disclosure also provides a sorbent for use in CO₂ capture comprising pores and having a surface area of 25-250 m²/g, a nitrogen content of 5-30% by weight, and a pore volume of 0.25-0.7 cm³/g, wherein the sorbent may be formed by a grafting-from technique between a support resin and an amine-containing polymer. The sorbent may be a polyalkylenimine polymer. The support resin may be made of monomers including vinylbenzylchloride, styrene, divinylbenzene, or a combination thereof, or the support resin may be a chloromethylated polystyrene-divinylbenzene resin.

The present disclosure also provides a method for CO₂ capture from aqueous environments, the steps comprising: providing a sorbent having a nitrogen content of 5-30% by weight and a particle size of 400-50 mesh, wherein the sorbent is formed by the steps comprising: providing a support resin and cyclic imino ether-containing monomer compound; and, grafting the cyclic imino ether-containing monomer compound off the support resin using a grafting-from technique, hydrolyzing the grafted polyoxazoline branches to polyalkyleneimines; and contacting an aqueous stream containing dissolved CO₂, carbonic acid, bicarbonate, or carbonate ions to be removed with the sorbent. The grafting-from method may be a ring-opening polymerization followed by acidic hydrolysis. The method does not comprise using any grafting-to technique to form the sorbent, and amine-containing branches may be grown from the support resin.

In an embodiment, the sorbent may have a nitrogen content of 20-25% by weight. The sorbent may not comprise any primary, tertiary, or quaternary amines. In another embodiment, the sorbent may have a bicarbonate uptake of at least 2.5 mmol/g, or at least 3 mmol/g.

The present disclosure provides a method for CO₂ capture from gaseous environments, the steps comprising: providing a sorbent comprising pores and having a surface area of 25-250 m²/g, a nitrogen content of 5-30% by weight, a pore volume of 0.25-0.7 cm³/g, wherein the sorbent is formed by the steps comprising: providing a support resin and a monomer containing a cyclic imino ether, such as 2-oxazolines or 5,6-dihydro-4H-1,3-oxazines; and polymerizing the monomer off of the support resin using a grafting-from technique, hydrolyzing the grafted polyoxazoline branches to polyalkyleneimines; and contacting a gaseous stream containing CO₂ to be removed with the sorbent. The grafting-from method may be a ring-opening polymerization followed by acidic hydrolysis. The method may not comprise using any grafting-to technique to form the sorbent, and amine-containing branches may be grown from the support resin.

In an embodiment, the gaseous stream contains greater than 400 ppm of CO₂, and the method may further comprise the step of removing more than 10% mol CO₂ per mol nitrogen in the sorbent, more than 12% mol CO₂ per mol nitrogen in the sorbent, more than 15% mol CO₂ per mol nitrogen in the sorbent, 10-30% mol CO₂ per mol nitrogen in the sorbent, 12-30% mol CO₂ per mol nitrogen in the sorbent, or 15-30% mol CO₂ per mol nitrogen in the sorbent. The sorbent may not comprise any primary, tertiary, or quaternary amines beyond trace impurities. The sorbent may be regenerable. The support resin may be made of monomers, including vinylbenzylchloride, styrene, divinylbenzene or a combination thereof, or the support resin may be a chloromethylated polystyrene-divinylbenzene resin. The sorbent may be a grafted polyalkylenimine polymer active phase. The nitrogen content may be 10-15% by weight. The surface area may be 30-100 m²/g, 40-100 m²/g, 50-100 m²/g, 60-100 m²/g, 30-90 m²/g, 30-80 m²/g, or 30-70 m²/g.

Other methods, embodiments, and variations of CO₂ capture are described in greater detail in the following discussion.

### BRIEF DESCRIPTION OF DRAWINGS

The support is described referring to the accompanying drawings, which show preferred embodiments according to the method described. The method as disclosed in the accompanying drawings are illustrated for example only. The elements and combination of elements described below and illustrated in the drawings can be arranged and organized differently to result in embodiments still within the spirit and scope of the device described.

These and other features, aspects, and advantages of the embodiments will become better understood regarding the following description, appended claims, and accompanying drawings.

FIG. 1A is an embodiment of synthesis of grafted-from.

FIG. 1B is an embodiment of synthesis from grafted-to pre-made LPEI, secondary amines only.

FIG. 1C is an embodiment of synthesis from grafted-to short chain polyamines with primary amine ends.

FIG. 2 is an embodiment of a simplified synthesis of grafted-from sorbents.

FIG. 3 is a graphical representation of CO₂ uptake by graft copolymer sorbents in pure CO₂ at 18 °C, 30 °C, 40 °C, and 60 °C.

FIG. 4 is a graphical representation of an embodiment of isothermal CO₂ uptake at 15 °C for grafted-from and grafted-to sorbents.

FIG. 5 is a graphical representation of an embodiment isothermal CO₂ uptake at 30 °C for grafted-from and grafted-to sorbents.

FIG. 6 is a graphical representation of an embodiment of CO₂ uptake for grafted sorbents in 4% CO₂ atmosphere from 30-100 °C.

FIG. 7 is a graphical representation of DAC performance of grafted sorbent (Version A) using different binder polymers.

FIG. 8 is a graphical representation direct air capture data comparing grafted sorbent to impregnated sorbent.

FIG. 9 is a graphical comparison of grafted sorbent to impregnated sorbent for CO₂ capture cycles mimicking Natural Gas Combined Cycles

FIG. 10 is an embodiment of a sorbent cycle for aqueous CO₂ capture using grafted sorbent (Version B).

FIG. 11 is an embodiment of an aqueous CDR/alkalinity enhancement cycle using CO₂-derived acetic acid.

FIG. 12 is an embodiment of an aqueous CDR/alkalinity enhancement cycle using CO₂-derived formic acid.

The drawing figures are not drawn to scale, or proportion, but instead are drawn to provide a better understanding of the components, and are not intended to be limiting in scope, but rather provide exemplary illustrations.

### DETAILED DESCRIPTION

A better understanding of different embodiments of the support may be gained from the following description read with the accompanying drawings in which like reference characters refer to like elements.

While the disclosure is susceptible to various modifications and alternative constructions, certain illustrative embodiments are in the drawings and will be described below. It should be understood, however, there is no intention to limit the disclosure to the embodiments disclosed, but on the contrary, the invention covers all modifications, alternative constructions, combinations, and equivalents falling within the spirit and scope of the disclosure and defined by the appended claims.

### Glossary

It will be understood that, unless a term is defined in this disclosure to possess a described meaning, there is no intent to limit the meaning of such term, either expressly or indirectly, beyond its plain or ordinary meaning.

“Graft copolymers” are polymers with branches, also known as side chains, of a different type from the main backbone chain, attached covalently. They may be formed by grafting-to or grafting-from techniques.

“Grafting-to” methods or techniques for forming graft copolymers involve attaching pre-made side chains with multiple repeating monomer units to the backbone polymer via a coupling reaction.

Grafting-to methods involve reacting an existing amine-containing structure onto an existing support and are limited by the reactivity of the surface groups with the desired amines.

“Grafting-from” methods or techniques for forming graft copolymers involve initiating the polymerization of the side chains from the backbone polymer itself, which has been modified to contain active sites, also known as initiators. The side chains are essentially grown from the backbone polymer, and the backbone is effectively a macroinitiator. The side chains are grown one monomer repeat unit at a time. The grafting-from method allows for the synthesis of graft copolymers with well-defined side chains, high grafting densities, and narrow molecular weight distributions. The side chain length can be controlled by adjusting polymerization distributions.

Grafting-from involves growing the active phase directly off the support surface by polymerizing a monomer, and in which the support surface acts as the polymerization initiator. In this invention, the nitrogen contents and morphologies achieved by grafting-from lead to sorbents that outperform both non-grafted, or impregnated, and grafted-to materials, for CO₂ capture from both gaseous and aqueous environments.

Any element in a claim that does not explicitly state “means for” performing a specified function, or “step for” performing a function, is not to be interpreted as a “means” or “step” clause as specified in 35 U.S.C. § 112, paragraph 6.

### Invention

This disclosure describes carbon dioxide removal (“CDR”) processes for atmospheric and aqueous environments with grafted-from, copolymer sorbents. Aqueous environments may include the ocean, or freshwater sources. The sorbents may have specific physical and compositional properties that enable them to outperform current materials in one or both applications, while still employing LPEI or other linear polyalkyleneimines, such as linear polypropyleneimine (“LPPI”), as the active phase. In some embodiments, the sorbent may be tailored to DAC applications while in other embodiments, the sorbent may be tailored to aqueous applications. Version A is an example of the sorbent tailored to gas capture applications, and Version B is an example of the sorbent tailored to aqueous applications. Such versions are not meant to be limiting to their application but serve as examples.

The present disclosure describes the increase in CO₂ uptake efficiency when using grafted-from sorbents compared with grafted-to sorbents, and the use of these grafted-from sorbents in DAC and DOC applications. The grafted-from sorbents have structural differences compared to the grafted-to sorbents which is evidenced in the higher nitrogen concentration. A primary difference between the grafted-from and the grafted-to sorbents is the number of repeating monomer units attached to successful graft initiation points, as the grafting-to sorbents are limited to pre-made chain lengths, whereas grafting-from may contain varied chain lengths based on the morphology of the resin, pores, and locations of active grafting points. Optimal chain length may result in higher sorption ratios. Optimization may occur when chain length is increased.

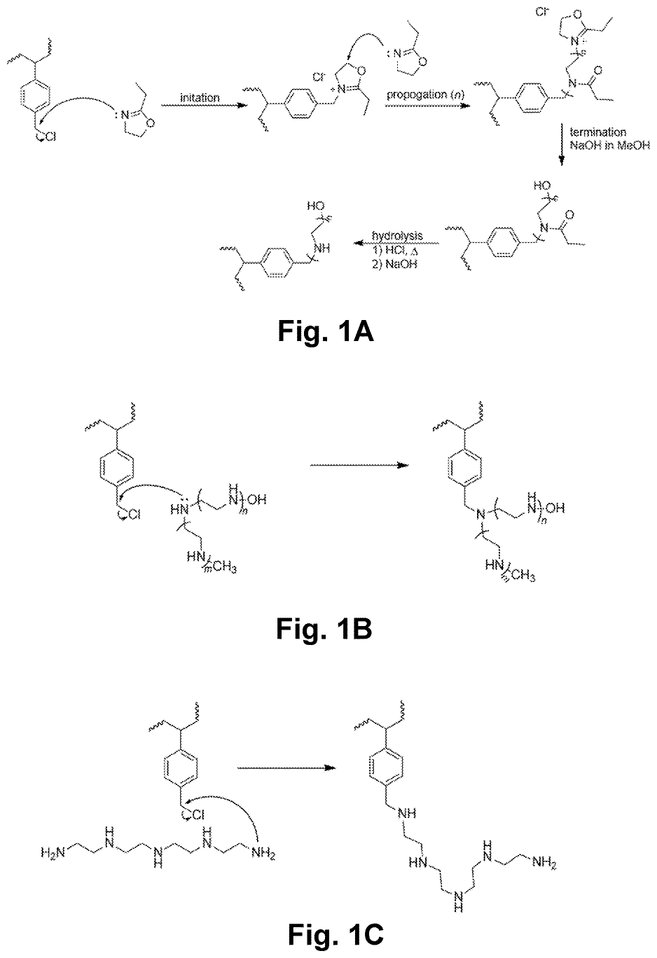

The amount of unreacted initiation sites may be lower in the grafted-from sorbents. FIG. 1A is an embodiment of synthesis of grafted-from for comparison. FIG. 1B shows grafting-to utilizing a starting LPEI with only secondary amines, which react with the C—Cl bond to form a tertiary amine at the graft point. FIG. 1C shows grafting-to with short-chain polyamines (such as TEPA, PEHA, TETA, DETA) with primary amine ends that become the secondary amine attachment point. The advantage of grafting-from as in FIG. 1A is the increased nitrogen content and chain lengths required for effective CO₂ removal from gaseous streams. When grafted-to sorbents were prepared and compared to grafted-from, grafted-to sorbents showed lower CO₂ capacities, higher unreacted sites, and lower nitrogen contents.

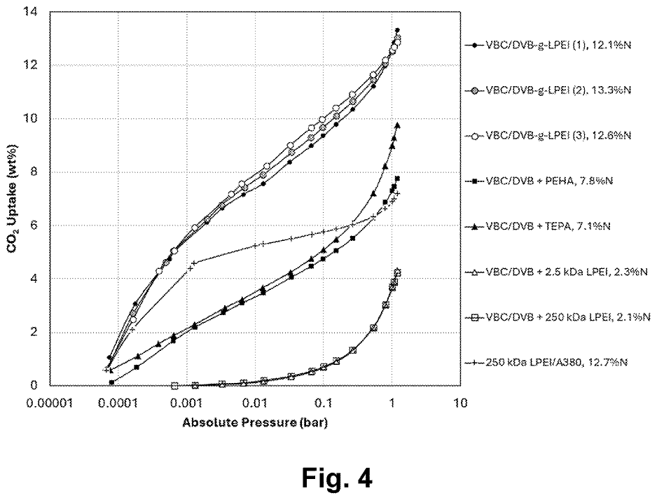

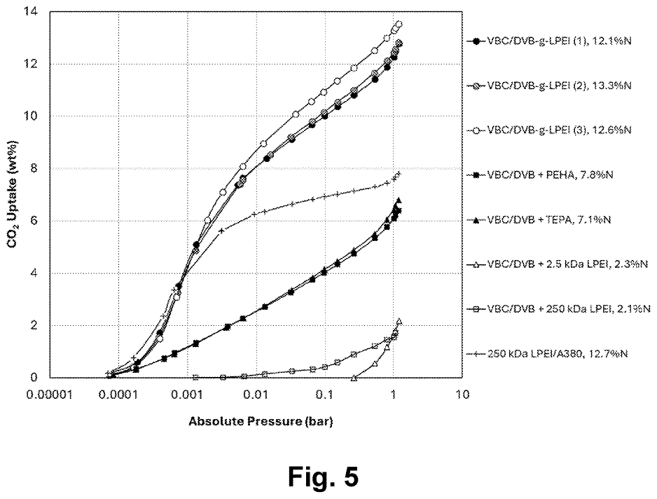

FIG. 5 shows that both mechanisms for forming grafted-to sorbents produce inferior CO₂ uptake efficiency compared to grafted-from sorbents. This is shown in FIG. 4 and FIG. 5 for VBC/DVB+PEHA, VBC/DVB+TEPA, and VBC/DVB+LPEI (2.5 and 250 kDa) grafted-to samples. The morphology of LPEI grafted-from sorbents may allow increased CO₂ uptake in DAC applications compared to LPEI impregnated on porous, high surface area polymer resins or inorganic supports, for example silica, alumina, or the like, so-called ‘conventional, impregnated sorbents’, which are not grafted. An embodiment of the disclosed grafted-from sorbent may achieve 1-10 wt % in DAC CO₂ uptake.

Alternatively, embodiments of the grafted-from sorbent may achieve 1-9 wt %, 1-8 wt %, 1-7 wt %, 2-9 wt %, 2-8 wt %, 2-7 wt %, 3-9 wt %, 3-8 wt %, 3-7 wt %, 4-9 wt %, 4-8 wt %, 4-7 wt %, 5-9 wt %, 5-8 wt %, or 5-7 wt % in DAC CO₂ uptake. Embodiments of the grafted-from copolymer sorbent may exhibit enhanced uptake at cooler temperatures, for example 18 °C, in atmospheres with 400 ppm CO₂ or greater and regenerate rapidly and at mild conditions. In some embodiments, applicable atmospheres have CO₂ levels of 400-2000 ppm.

The DAC sorbent may be imbued with these traits by grafting-from a support polymer with high surface area and pore volume, small particle size of 125 μm or less, 150 μm or less, 200 μm or less, 250 μm or less, 300 μm or less, 350 μm or less, or less than 400 μm and tunable hydrophobicity. The DAC sorbent may be a powder, beads, mesh, or any other like material. The morphology may be optimized to increase surface area.

The grafted copolymer sorbent may contain a similar amount of nitrogen as incumbent materials. The amount of nitrogen in incumbent materials may be 5-15 wt %. In some embodiments, the amount of nitrogen in incumbent materials is 5-14 wt %, 5-13 wt %, 6-15 wt %, 6-14 wt %, 6-13 wt %, 7-15 wt %, 7-14 wt %, 7-13 wt %, 8-15 wt %, 8-14 wt %, 8-13 wt %, 9-15 wt %, 9-14 wt %, 9-13 wt %, 10-15 wt %, 10-14 wt %, 10-13 wt %, 11-15 wt %, 11-14 wt %, 11-13 wt %, 12-15 wt %, 12-14 wt %, or 12-13 wt %.

The grafted copolymer sorbent may have nitrogen utilization of 10-30%. Nitrogen utilization may mean mol CO₂ captured/mol N and may also be referred to as N efficiency or N utilization. In some embodiments, the nitrogen utilization may be 10-25%, 10-20%, 10-15%, 15-30%, 15-25%, 15-20%, 20-30%, 20-25%, or 25-30%.

The disclosed grafted-from sorbents may have improved carbon uptake as the polymer chains are able to form and orient in ways that allow better access of the gas to the amines. This may be based on varying lengths of the chains grown from within pores in the resin, whereas pre-made chains or conventionally impregnated chains may suffer from steric hinderances when attaching or adhering to the support resin. Also, this could include being non-crystalline and less entangled chains since they are each a tendril connected to the graft point.

Chain lengths, after grafting, may be more than 3 repeating units, more than 3.5 repeating units, more than 4 repeating units, more than 4.5 repeating units, more than 5 repeating units, more than 5.5 repeating units, more than 6 repeating units, more than 7 repeating units, more than 8 repeating units, more than 9 repeating units, more than 10 repeating units, more than 11 repeating units, more than 12 repeating units, more than 13 repeating units, more than 14 repeating units, more than 15 repeating units, more than 16 repeating units, more than 17 repeating units, more than 18 repeating units, more than 19 repeating units, more than 20 repeating units, more than 21 repeating units, more than 22 repeating units, more than 23 repeating units, or more than 24 repeating units.

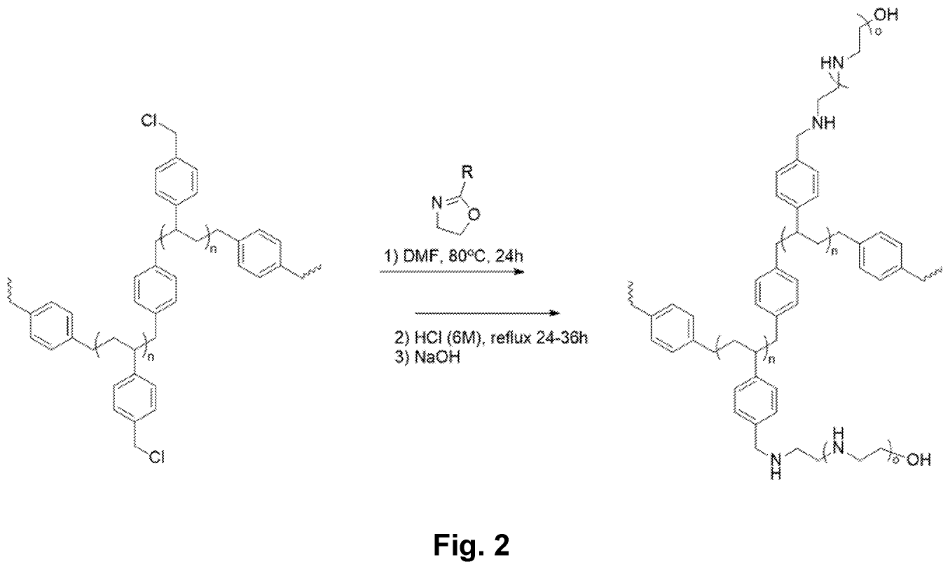

It is unexpected that the grafted-from sorbents have superior performance in DAC and DOC applications compared to grafted-to sorbents. For grafted-to sorbents, the crosslinked support resin is mixed with polyalkyleneimine to react the chloro-groups with the amines directly, forming a sorbent product with the same resin backbone and repeat units on side chains as in FIG. 2. However, the grafted-to copolymers have been tested for DAC and DOC and do not work as well, as shown in isotherm figures, % N values, and BET data.

The exemplary version A is characterized by a substrate resin including monomers, where the monomers are at least one of 4-vinylbenzylchloride, styrene, divinylbenzene, or a combination thereof. The substrate resin may be made of a 4-vinylbenzylchloride, divinylbenzene mixture with a ratio of 1:3, or a mixture of 4-vinylbenzylchloride, styrene, and divinylbenzene with a ratio of 0.5:0.5:3. 4-Vinylbenzylchloride may be substituted for other vinyl monomers with a chloromethyl group.

The substrate resin may have a high surface area, high porosity, and less than 125 μm particle size, coupled with nitrogen contents of 5-20% by weight, or 10-15 wt % N, and in which the nitrogen may be contained within linear polyalkyleneimine polymer grafted-from the surface of the substrate resin in a two-step process shown in FIGS. 1A-1C and FIG. 2.

High surface area may mean that the surface area before grafting is more than 100 m²/g, more than 150 m²/g, more than 200 m²/g, more than 250 m²/g, more than 300 m²/g, more than 350 m²/g, more than 400 m²/g, more than 450 m²/g, more than 500 m²/g, more than 550 m²/g, more than 600 m²/g, more than 700 m²/g, 100-800 m²/g, 200-800 m²/g, 300-800 m²/g, 400-800 m²/g, 500-800 m²/g, 600-800 m²/g, or 700-800 m²/g. Surface area after grafting may be more than 15 m²/g, more than 20 m²/g, more than 25 m²/g, more than 30 m²/g, more than 35 m²/g, more than 40 m²/g, more than 45 m²/g, more than 50 m²/g, more than 55 m²/g, more than 60 m²/g, more than 65 m²/g, more than 70 m²/g, more than 75 m²/g, 15-75 m²/g, 20-75 m²/g, 30-75 m²/g, 40-75 m²/g, 50-75 m²/g, 60-75 m²/g.

The DAC application process involves common pressure, temperature, and/or concentration swing methods to release the CO₂ as pure gas after adsorption at ambient conditions. In an example, the support polymers for Version A of the sorbent were prepared by copolymerizing 4-vinylbenzyl chloride (“VBC”) and divinylbenzene (“DVB”) using radical initiator (“AIBN”) in ethyl acetate solvent under solvothermal condition at 90 °C for 48-72 hours, wherein the molar ratio of DVB:VBC was 3:1. Exemplary characterization of surface area and porosity, including the average pore volume and diameter, for before and after the grafting process, including substrates used for grafting and resulting grafted sorbents, are shown in Table 1.

TABLE 1

| | BET | Pore | Pore |
|---|---|---|---|
| | surface | volume | Diameter |
| Sample | area (m²/g) | (cm³/g) | (nm) |
| DVB/VBC = 3/1 | 615 | 1.86 | 12.5 |
| DVB/VBC-g-LPEI (Version A, | 63.3 | 0.33 | 18.4 |
| Example 1) | | | |
| DVB/VBC-g-LPEI (Version A, | 137 | 0.38 | 9.99 |
| Example 2) | | | |
| DVB/Styrene/VBC = | 587 | 1.60 | 11.3 |
| 3.0/0.5/0.5 | | | |
| DVB/VBC/Sty-g-LPEI | 195 | 0.96 | 19.1 |
| (Version A, Example 3) | | | |
| Merrifield peptide resin | N/A | N/A | N/A |
| (MPR) | | | |
| MPR-g-PEI (Version B, | 1.89 | N/A | N/A |
| Example 4) | | | |

Version B may be characterized by a low surface area support polymer, such as a Merrifield Peptide Resin or other chloromethylated polystyrene, divinylbenzene polymer resin with low surface area as seen in Table 1. Version B may have larger particle size and may have macroporosity to enable fast flow rates of water through the sorbent beds. The larger particle size may be 200-70 mesh (74-210 μm).

FIG. 2 shows a method of grafting-from the substrate resin, where the method may be the same as Version A, but the product may have different morphology and N content than Version A, reaching up to 25% N. Version B may leverage a support polymer with higher chlorine content distributed over less surface area, leading to more and longer chains of polyethyleneimine compared to Version A. The grafted-from sorbents may be prepared using known methods, conducting graft polymerization of monomers and subsequent hydrolysis reactions under the appropriate conditions to yield a grafted-from polyalkylenimine.

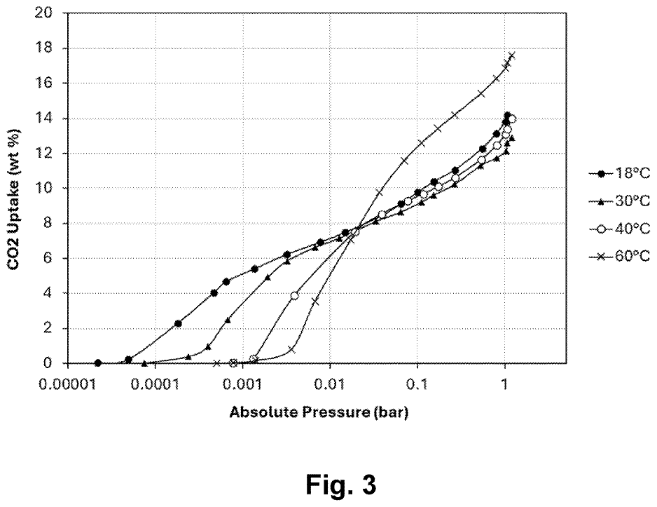

FIG. 3 shows an embodiment of CO₂ uptake under pure, isothermal CO₂ conditions. The temperature may be between 18-60 °C for gaseous conditions. Under low concentration CO₂ conditions, lower temperatures below 25 °C may show enhanced uptake, showing that the disclosed embodiment of sorbent may be utilized for DAC applications in mild or cold climates. Higher CO₂ partial pressures may enhance uptake for all temperatures. CO₂ partial pressures may be between 0.2-0.3 mmHg in the atmosphere, or 25-35 mmHg in a point-source or flue-gas atmosphere.

FIG. 4 and FIG. 5 compare isothermal uptake at 15 and 30 °C, respectively, for grafted-from sorbent in gaseous environments, such as Version A, to grafted-to sorbents. The grafted-to sorbents may include short chain and polymeric alkyleneimines, as well as a conventional, impregnated, non-grafted, polymeric alkyleneimine. FIG. 1C shows an embodiment of a mechanism, where pentaethylenehexamine (PEHA) and tetraethylenepentamine (TEPA) were used as short-chain polyamines. FIG. 1B shows where LPEI with molecular weights of 2,500 Da and 250,000 Da were used as polymeric alkyleneimines. Grafted-to sorbents may be prepared with the same batch of substrate VBC/DVB resin as the grafted-from sorbents.

In contrast, non-grafted sorbent may be composed of LPEI, which may have a molecular weight of 250,000 Da, impregnated on Aerosil A380 (“A380”), a fumed silica with high surface area. The surface area may be about 380 m²/g. Impregnation may be conducted by dissolving the polymer in alcohol, applying it onto the support, and drying, resulting in a 39 wt % loading of active phase on the support and corresponding 12.7 wt % N.

As illustrated in the figures, embodiments of the grafted-from sorbents outperform all grafted-to sorbents and the non-grafted sorbent. These charts also demonstrate that grafting-to LPEI to VBC/DVB is not effective; the embodiments of short chain compounds, such as PEHA and TEPA, work for grafting an active phase to a support. This is evident in the resulting % N from grafting-to: 2.1 and 2.3 wt % N was measured in the LPEI+VBC/DVB grafted-to samples, compared to 7.1 and 7.8 wt % for the TEPA and PEHA+VBC/DVB grafted-to samples, respectively.

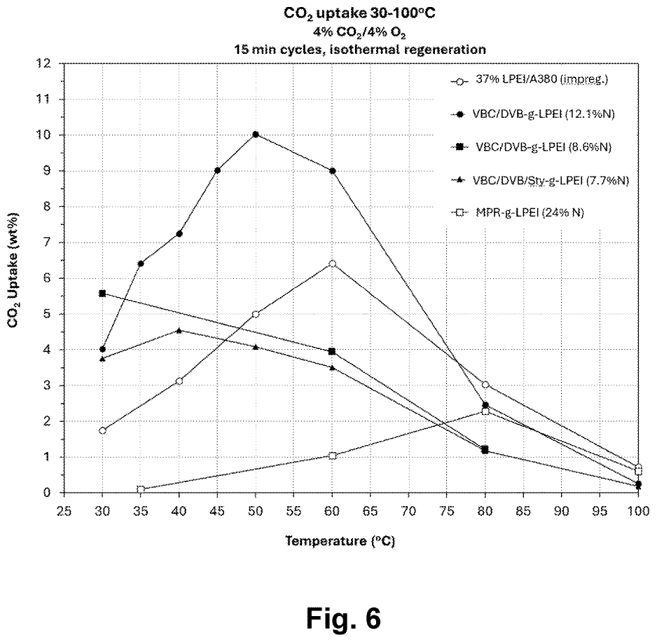

FIG. 6 shows an example of when Version A is exposed to a 4% CO₂/4% O₂ concentration representing flue gas, it is shown that the uptake peaks at 50 °C The data in FIG. 6 was collected from 15-minute cycles. The uptake at 80 °C may also be slightly lower than that of the non-grafted sorbent, suggesting sorbent regeneration is possible at milder temperatures.

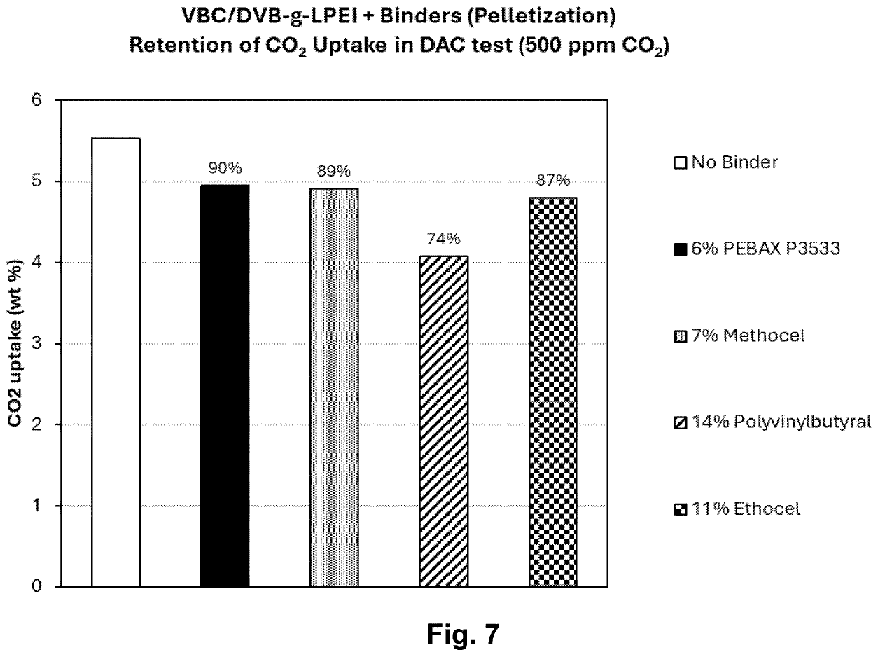

FIG. 7 shows an example of the sorbent formulated into pellets to eliminate pressure buildup without degrading the performance. Using binders such as Pebax 3533, a thermoplastic elastomer, or Methocel (methyl cellulose or hydroxypropyl methyl cellulose) at loadings less than 10 wt % of the sorbent enable extrusion of pellets and maintain 90% of the bare material's capacity in DAC conditions. The sorbent particles may be dispersed in the binder, but the binder does not remove accessible surface area. Alternative binders may include ethyl cellulose, Pebax 1657, Pebax Rnew, other Pebax polymers or like block copolymers of polyethers and polyamides, natural and synthetic rubbers based on polyisoprene, polybutadiene, and/or polystyrene copolymers, silicones, polyvinylalcohols, polyvinylbutyral, and alginates.

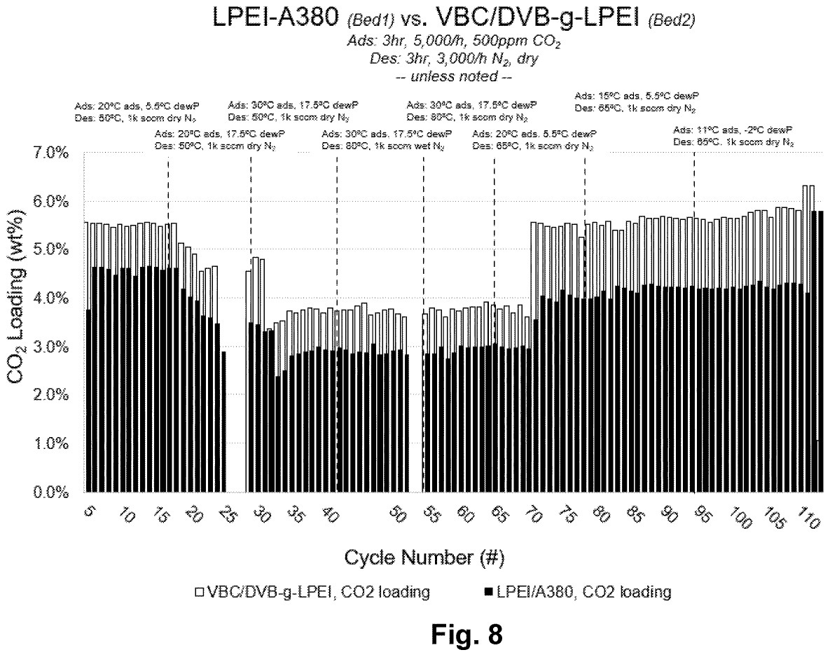

FIG. 8 shows an example of direct air capture data comparing grafted sorbent to impregnated sorbent for more than 100 cycles under DAC relevant conditions with 500 ppm CO₂. In this test, grafted-from Version A (VBC/DVB-g-LPEI) was combined with 4 wt % Pebax 3533 and extruded into 3-7 mm pellets. The impregnated sorbent (LPEI/A380) was extruded into pellets of similar dimensions without a binder. This may demonstrate the better performance of the sorbent in DAC. Considering both sorbents have 12-13 wt % N, the higher nitrogen efficiency of the grafted-from sorbent is realized. The nitrogen efficiency may be 10-20%, or greater than 12% efficiency, compared to 7% efficiency for the non-grafted sorbent.

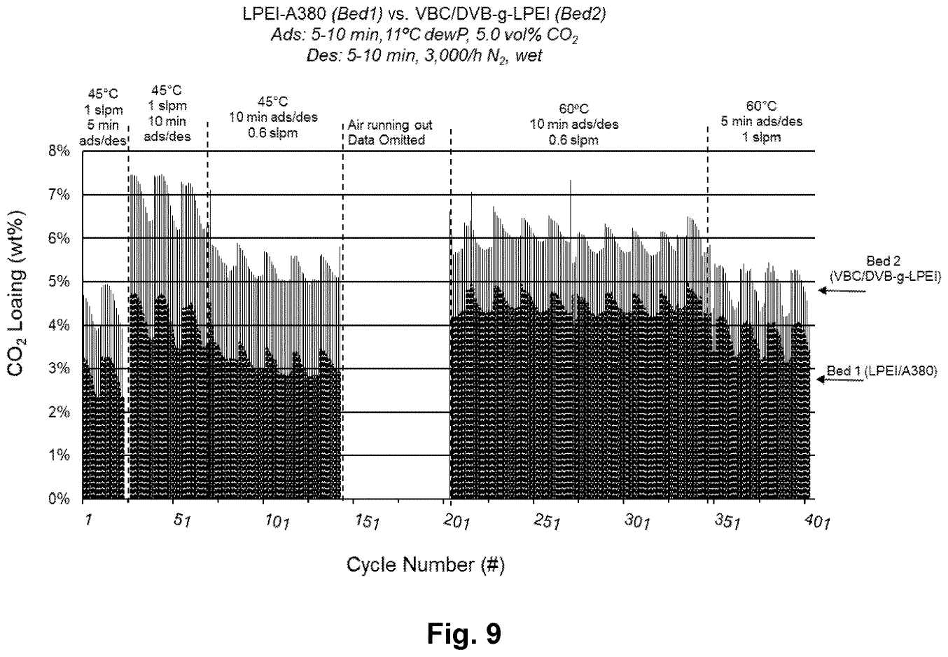

FIG. 9 shows a direct comparison of Version A and non-grafted sorbent for several hundred cycles in a reactor mimicking natural gas combined cycles (“NGCC”) with 5.0 vol % CO₂ and isothermal regeneration under nitrogen. This test was performed using the same pellets as described for the test in FIG. 8, after that data had been collected. This may demonstrate the better performance of the sorbent in point-source capture. Considering both sorbents have 12-13 wt % N, the higher nitrogen efficiency of the grafted-from sorbent is realized. The nitrogen efficiency may be 10-20%, or greater than 12% efficiency, compared to a maximum of 13% efficiency for the non-grafted sorbent.

When Version B is applied in an aqueous environment, the CO₂ removal capacity is up to 15 wt % or about 3.3 mmol CO₂/gram resin. Version B has 24 wt % nitrogen, which is greater than 2 times higher than commercial ion exchange resins. Additionally, all nitrogen may be within the grafted secondary amines, unlike the commercial resins which are primary, tertiary, or quaternary amines. This represents a maximum capacity measured in a 1 molar sodium bicarbonate solution which had been equilibrated to atmospheric CO₂.

The bicarbonate-saturated resin may be exposed to acid, generating CO₂ gas that may be collected and measured to yield this capacity. The alkalinity enhancing effect of sorbent Version B is demonstrated in Table 1, where even the most dilute bicarbonate solution of 0.002 molar, mimicking the concentration in the ocean, increased in pH by greater than 0.5 pH units. This demonstrates the ability to use the sorbent to remove CO₂ from dilute, aqueous environments without the need to add alkaline minerals or rely on electrochemistry to increase the pH and reverse CO₂-driven acidification.

Bicarbonate (HCO₃⁻) ions in water can come from various sources. Bicarbonate and carbonate salts create hydroxide (OH⁻) ions, making alkaline pH, while dissolved CO₂ generates protons (H⁺) ions toward acidic pH. Equation 1-3 are of sources of bicarbonate. Equation 1 shows bicarbonate from dissolved CO₂. Equation 2 shows bicarbonate from bicarbonate salt, and Equation 3 shows bicarbonate from carbonate salt dissolution.

CO_{2(g)}+H₂O [symbol] H₂CO_{3(aq)}

H₂CO₃ [symbol] H⁺+HCO₃⁻ Equation 1

NaHCO₃ [symbol] Na⁺+HCO₃⁻

HCO₃⁻+H₂O [symbol] H₂CO₃+OH⁻ Equation 2

CaCO₍₃₎ₛ+H₂CO_{3(aq)} [symbol] Ca₂⁺HCO₃⁻

2HCO₃⁻+2H₂O [symbol] 2H₂CO₃+2OH⁻

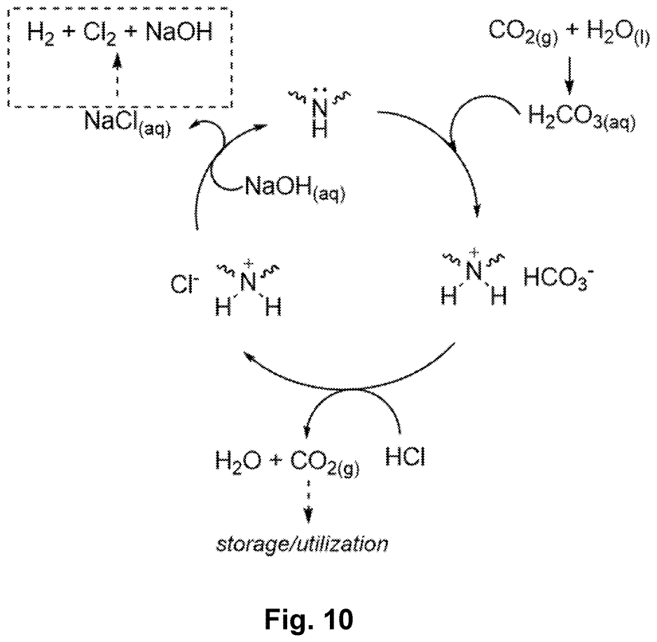

FIG. 10 shows a sorbent cycle. In the exemplary sorbent cycle, CO₂ in the atmosphere combines with water, creating carbonic acid (H₂CO₃) into the water. The carbonic acid may be aqueous. Carbonic acid dissociates into an acidic proton and a bicarbonate (HCO₃⁻) ion, wherein the basic resin can react with the acid and create an ammonium bicarbonate complex (NR₂H₂⁺HCO₃⁻) on the resin. It may also react with alkaline bicarbonate, such as sodium bicarbonate, to make an ammonium carbonate complex (2 NR₂H₂⁺CO₃²⁻) with another molecule of water. Regardless of which species is bound, the (bi) carbonate can be degraded into pure CO₂ gas by exposing the resin to acid such as HCl, creating an ammonium chloride complex on the resin which may be regenerated back to neutral amine by a strong base such as NaOH. In this embodiment, an NaCl, or ‘brine’, effluent is made in the process, with a stoichiometric relationship with CO₂. Providing this into the chlor-alkali process provides optional circularity for the required acid and base, reducing cost. The chlor-alkali process, shown in the top left, dashed box, of FIG. 10, is an example of where said process may create NaOH and the ingredients for HCl (H₂ and Cl₂).

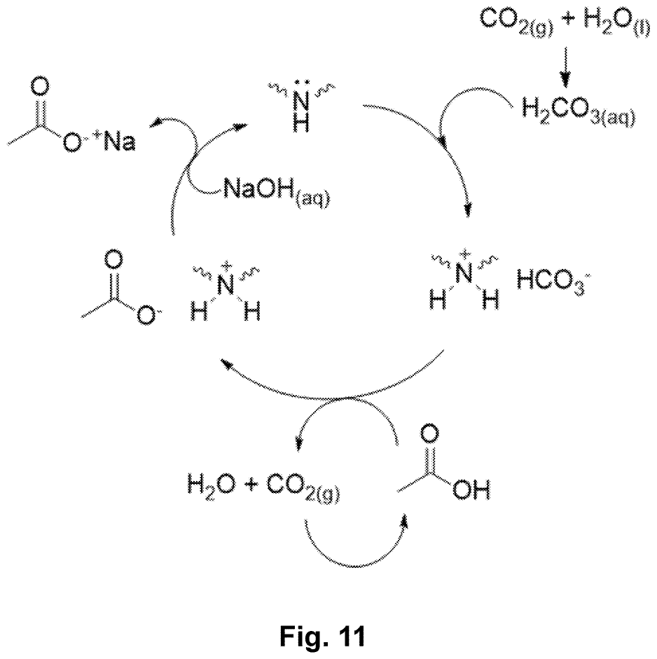

FIG. 11 shows another embodiment of aqueous CDR with Version B of the grafted-from sorbent, where the captured CO₂ may be converted to acetic acid, which may then be used for the CO₂ gas release step. Sodium acetate may also be discharged from regeneration with NaOH.

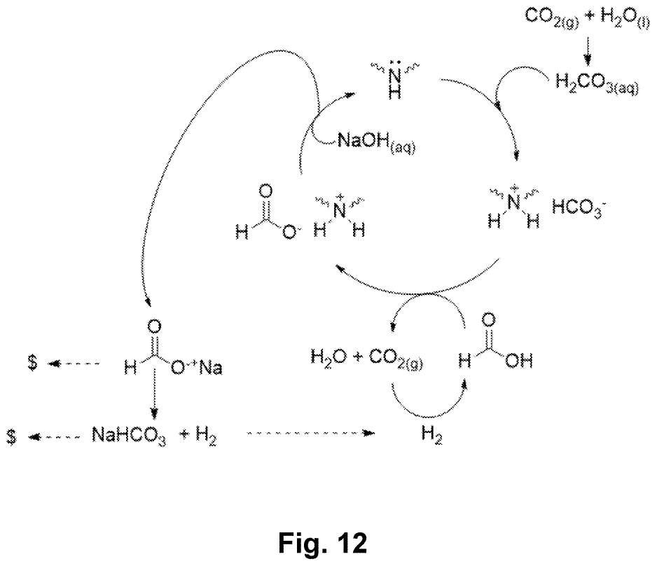

FIG. 12 shows another embodiment of the aqueous CDR capture process, in which CO₂ may be converted to formic acid by hydrogenation, which may then be used for the CO₂ gas release step. Upon regeneration with NaOH, the discharged sodium formate can be used or converted to sodium bicarbonate by dehydrogenation. Released hydrogen can be recycled into the CO₂-to-formic acid process. The various processes with different acid flows allow flexible adaptation of this process to different environments.

Example 1: Version A for DAC or point source CO₂ capture applications is prepared by synthesizing the support resin, conducting graft polymerization of 2-ethyloxazoline (EtOX) from the chlorinated surface, and a subsequent hydrolysis to yield the final product, which was subjected to physiochemical characterizations and the CO₂ adsorption/regeneration processes. The substrate resin “VBC/DVB” was prepared with a 1:3 molar ratio of 4-vinylbenzylchloride to divinylbenzene in ethyl acetate at 75 °C for 72 h. The resin exhibits a BET surface area of 615 m²/g, pore volume of 1.86 cm³/g, and average pore diameter of 12.5 nm (Table 1). The chlorine content is 6.66% by weight. Grafting-from was performed with 5.00 g of the substrate resin, 5.19 g KI, anhydrous dimethylformamide (63 mL), and 38.7 g EtOX at 80 °C for 24 h. After washing the grafted product with methanol and drying, 12.0 g of VBC/DVB-g-P (EtOx) was recovered and hydrolyzed in 6M HCl (100 mL) for 36-48 h under reflux. The resin was separated and pH increased to 13 with NaOH, then filtered and rinsed to neutral pH to yield VBC/DVB-g-LPEI. The sorbent surface area was measured to be 63.3 m²/g with a pore volume of 0.33 cm³/g and average pore diameter of 18.4 nm (Table 1). The nitrogen content is 12-14% by weight. The CO₂ adsorption activity and DAC reactor results are presented in FIGS. 2-9.

Example 2: Version A of the sorbent was prepared by the procedure described in Example 1, targeting a lower nitrogen content. The VBC/DVB substrate resin used in Example 1 was used for Example 2 and graft copolymerization conducted in the same manner. 0.52 g of VBC/DVB, 2.04 g 2-methyl-oxazoline (MeOX), 0.28 g KI, and 8 mL DMF were reacted at 80 °C for 6 h, yielding 0.75 g VBC/DVB-g-P (MeOX). Hydrolysis was conducted with 10 mL 4.5M HCl for 36 h. After pH adjustment, washing, and drying, the obtained VBC/DVB-g-LPEI exhibited a nitrogen content of 8.6% by weight. Morphology data is presented in Table 1 and CO₂ adsorption activity is presented in FIG. 6.

Example 3: Version A of the sorbent was prepared by the procedure described in Example 1, using a substrate resin comprised of VBC, styrene, and DVB. The substrate resin was prepared as described in example 1, substituting ½ the VBC for styrene and maintaining a ratio of 3:1 DVB:[VBC+Styrene], resulting in a substrate resin with BET surface area of 587 m²/g, pore volume of 1.60 cm³/g, and average pore diameter of 11.3 nm (Table 1). The chlorine content was 3.11% by weight. Grafting and hydrolysis was conducted in the same manner as Examples 1 with 5.8 g EtOX, 0.32 g KI, and 12 mL anhydrous DMF at 80 °C for 36 h. The resin was washed and isolated as in Example 1, yielding 2.80 g VBC/Styrene/DVB-g-P (EtOX). The grafted resin was hydrolyzed in 25 mL 4.5M HCl at reflux for 36 h and isolated in the same manner as Example 1, resulting in VBC/Styrene/DVB-g-LPEI with nitrogen content of 7.7% by weight, a BET surface area of 195 m²/g, pore volume of 0.96 cm³/g, and average pore diameter of 19.1 nm (Table 1). The CO₂ adsorption activity is presented in FIG. 6.

Example 4: Version B of the sorbent was prepared using Merrifield's peptide resin as the substrate. The commercial chloromethylated polystyrene resin (1% crosslinked, 200-400 mesh, 3.5-4.5 mmol/g CI) was measured to have 13.6% CI by weight and no measurable surface area by BET. Merrifield resin (1.5 g), 22.5 mL anhydrous DMF, 1.12 g KI overnight, and 13.4 g EtOX were reacted at 80 °C for 42 h. The grafted resin was filtered and washed with methanol, yielding 12.2 g Merrifield-g-P (EtOX). Hydrolysis was conducted in 6M HCl (125 mL) at reflux for 36 h and the resin was filtered, stirred in 100 mL 2.5M NaOH for 2 h, then filtered and rinsed to neutral pH with DI H₂O. The obtained Merrifield-g-LPEI exhibits a nitrogen content of 24.1% nitrogen by weight (17 mmol N/g) and BET surface area of 1.89 m²/g. As shown in FIG. 6, the CO₂ activity profile is not fit for air capture applications. The capacity for aqueous CO₂ uptake was determined by soaking 0.2 g resin in excess 1M sodium bicarbonate solution (35 mL, equilibrated with atmospheric CO₂) followed by exposure to HCl. The evolved gas was allowed to collect in a eudiometer tube. The volume CO₂ collected in the tube was converted to a partial pressure, correcting for the atmospheric pressure, water temperature, and water vapor pressure, and converting this value to moles of gas to yield the theoretical CDR capacity of 3.3 mmol/g. The alkalinity enhancing effect of the sorbent is demonstrated in Table 2.

TABLE 2

| [NaHCO₃], | Ratio of | pH | pH | |
|---|---|---|---|---|
| Volume | NaHCO₃ to N | Before | After | pH Δ |
| 0.2M, 34 mL | 2:1 | 8.88 | 9.36 | 0.48 |
| 0.02M, 340 mL | 2:1 | 8.58 | 9.09 | 0.54 |
| 0.002M, 1 L | 0.6:1 | 8.36 | 8.91 | 0.55 |

A summary of the characteristic qualities of the grafted-from polymers, for example substrate A and substrate B before and after grafting, is shown in Table 3. This data differentiates grafted-from polymers from grafted-to polymers, though they have the same resin backbone and grafted repeat unit, which are typically used to classify polymers. Two polymers with the same structural repeat unit but different chain lengths are classified as the same polymer, so both sorbents may be classified the same despite structural differences described herein. The grafted-from copolymers have enhanced CO₂ uptake capabilities compared to grafted-to copolymer sorbents.

TABLE 3

| | | | | | | Sorbent |
|---|---|---|---|---|---|---|
| | Substrate A | | Sorbent Version | | Substrate B | Version B |
| | VBC/(Sty)/DVB | | A (Gas) | | MPR | (AQ) |
| | Before | | After | | Before | After |
| | grafting | | grafting | | grafting | grafting |
| Attribute | values | | values | | values | values |
| Surface Area | 100-800 | m²/g, | 25-250 | m²/g, | n/a | n/a |
| Surface Area | n/a | | >65% | | n/a | n/a |
| Loss from | | | | | | |
| Grafting | | | | | | |
| Pore Volume | 1.5-2.0 | cm³/g, | 0.25-0.7 | cm³/g, | n/a | n/a |

| Pore filling % | >70% | | >60% | n/a | n/a |
|---|---|---|---|---|---|
| from grafting | | | | | |
| Pore Diameter | 8-25 | nm | n/a | n/a | n/a |

| Particle Size | 100%: <125 μm | 100%: <125 μm | | 400-50 mesh | 400-50 | mesh |
|---|---|---|---|---|---|---|
| | 80%: 1-75 μm | 85%: 1-65 μm | | | | |
| | 50%: 10-15 μm | 50%: 10-15 μm | | | | |
| % N | 0 | 5-20% | | 0 | 5-30% | |
| mmol N to | 0 | 0.025-0.25 | | n/a | n/a | |
| surface area | | | | | | |
| ratio | | | | | | |
| % Cl | 1.5-15%, | 1-3.5%, | | 1.5-15% | <1% | |
| mmol Cl to | 0.0007-0.007 | n/a | | n/a | n/a | |
| surface area | | | | | | |
| ratio | | | | | | |
| Grafted chain | n/a | 4-14 | | n/a | 3.5-25 | |
| length | | | | | | |
| DAC CO₂ | n/a | 1-8 | wt % | n/a | n/a | |
| Uptake | | | | | | |
| DAC N | n/a | 10-20%, | | n/a | n/a | |
| Efficiency | | | | | | |

| | | | | | |
|---|---|---|---|---|---|
| 4% CO₂ | n/a | 1-12 | wt %, | n/a | n/a |

| Uptake at | | | | | |
|---|---|---|---|---|---|
| 50-60 °C | | | | | |
| 4% CO₂, | n/a | 10-30% mol | n/a | n/a | |
| 50-60 °C | | CO₂/mol N | | | |
| N Efficiency | | | | | |
| Bicarbonate | n/a | n/a | n/a | 2.5-3.5 | mmol/g |

uptake (AQ
version only)

Substrate A may alternatively have a surface area of 300-750 m²/g, 300-700 m²/g, 300-650 m²/g, 300-600 m²/g, 300-550 m²/g, 300-500 m²/g, 300-450 m²/g, 100-800 m²/g, 150-800 m²/g, 200-800 m²/g, 250-800 m²/g, 100-500 m²/g, less than 800 m²/g, less than 750 m²/g, less than 700 m²/g, less than 650 m²/g, less than 600 m²/g, less than 550 m²/g, or less than 500 m²/g.

Sorbent A may alternatively have a surface area of 25-200 m²/g, 25-175 m²/g, 25-150 m²/g, 25-125 m²/g, 25-100 m²/g, 35-200 m²/g, 35-175 m²/g, 35-150 m²/g, 35-125 m²/g, or 35-100 m²/g.

Substrate A may alternatively have a pore volume of greater than 1.5 cm³/g, greater than 1.6 cm³/g, greater than 1.7 cm³/g, greater than 1.8 cm³/g, greater than 1.9 cm³/g, 1.6-2.0 cm³/g, 1.7-2.0 cm³/g, 1.8-2.0 cm³/g, or 1.9-2.0 cm³/g.

Sorbent A may alternatively have a pore volume of less than 0.7 cm³/g, less than 0.6 cm³/g, less than 0.5 cm³/g, less than 0.4 cm³/g, less than 0.3 cm³/g, less than 0.2 cm³/g, 0.3-0.7 cm³/g, 0.4-0.7 cm³/g, 0.5-0.7 cm³/g, 0.6-0.7 cm³/g, 0.25-0.6 cm³/g, 0.25-0.5 cm³/g, 0.25-0.4 cm³/g, or 0.25-0.3 cm³/g.

In substrate A, the pore diameter before grafting may alternatively be, 8-20 nm, 8-15 nm, 8-14 nm, 8-13 nm, 8-12 nm, 8-11 nm, 8-10 nm, 9-20 nm, 9-15 nm, 9-13 nm, 10-20 nm, 10-15 nm, or 10-13 nm.

Sorbent Version A may alternatively have a % N of 5-17%, 5-15%, 5-13%, 5-12%, 7-20%, 7-17%, 7-15%, 7-13%, 7-12%, 10-20%, 10-17%, 10-15%, 10-13%, or 10-12%.

Sorbent Version B may alternatively have a % N of 5-25%, 10-30%, 10-25%, 10-22%, 15-30%, 15-25%, 15-20%, 20-30%, 20-25%, or 20-22%.

Substrate A may alternatively have a % CI of 2-15%, 4-15%, 6-15%, 1.5-12%, 1.5-10%, 1.5-8%, 1.5-7%, 3-15%, 3-12%, 3-10%, 3-8%, 3-7%, 6-12%, 6-10%, 6-8%, or 6-7%.

Sorbent Version A may alternatively have a % CI of 1-3%, 1-2.5%, 1-2%, 1-1.5%, 1-1.25%, less than 3%, less than 2.5%, less than 2%, less than 1.5%, or less than 1.25%.

Substrate B may alternatively have a % CI of 2-15%, 5-15%, 7-15%, 10-15%, 1.5-12%, or 1.5-10%.

Sorbent Version B may alternatively have a % CI of less than 0.75%, less than 0.5%, or less than 0.25%.

Sorbent Version A may alternatively have a grafted chain length of 5-14, 5.6-14, 6-14, 7-14, 8-14, 9-14, 10-14, 11-14, 12-14, or 13-14. Sorbent Version A may alternatively have a grafted chain length of 4-25, 4.5-25, 5-25, 5.6-25, 6-25, 8-25, 10-25, 12-25, 14-25, 16-25, 18-25, 20-25, 22-25, or 24-25.

Sorbent Version A may alternatively have a DAC CO₂ uptake of 2-8%, 3-8%, 4-8%, 5-8%, or 6-8%. It may also have a DAC N Efficiency of 11-20%, 12-20%, 13-20%, 14-20%, or 15-20%. For 4% CO₂ uptake at 50-60 °C, Sorbent Version A may alternately have 2-12 wt %, 3-12 wt %, 4-12 wt %, 5-12 wt %, 6-12 wt %, or 7-12 wt %. Similarly, with 4% CO₂ at 50-60 °C, the N efficiency of Sorbent Version A may alternatively be 12-30%, 15-30%, 18-30%, 20-30%, 22-30%, or 25-30%.

Sorbent Version B may alternatively have a bicarbonate uptake of up to 3.5 mmol/gram, 2.7-3.5 mmol/gram, or 3-3.5 mmol/gram.

The binder in Sorbent Version A may alternatively have less than 10% binder loading and/or less than 15% activity loss.

It is to be understood that not necessarily all objects or advantages may be achieved under any embodiment of the disclosure. Those skilled in the art will recognize that the system for CO₂ capture, may be embodied or carried out in a manner that achieves or optimizes on an advantage or group of advantages taught without achieving other object or advantages as taught or suggested.

The skilled artisan will recognize the interchangeability of various disclosed features. Besides the variations described, other known equivalents for each feature can be mixed and matched by one of ordinary skill in this art to make or use a system for CO₂ capture. It will be understood by the skilled artisan that the features described may be adapted to other species or processes.

Although this disclosure describes certain exemplary embodiments and examples of CO₂ capture, it therefore will be understood by those skilled in the art that the present disclosure extends beyond the specifically disclosed embodiments to other alternative embodiments and/or uses of the disclosure and obvious modifications and equivalents thereof. It is intended that the present disclosure should not be limited by the particular disclosed embodiments described above.

1. A grafted copolymer sorbent for use in CO₂ capture, the grafted copolymer sorbent comprising:
a support resin;
a plurality of grafted polyethyleneimine branches, the support resin and the plurality of grafted polyethyleneimine branches having a combined surface area of 25-250 m²/g;
a nitrogen content of 5-30% by weight, and
a pore volume of 0.25-0.7 cm³/g,
wherein the grafted copolymer sorbent is formed using a grafting-from technique to grow the polyethyleneimine branches from the support resin.

2. The sorbent as in claim 1, wherein the support resin is made of monomers including vinylbenzylchloride, styrene, divinylbenzene, or a combination thereof, or wherein the support resin is a chloromethylated polystyrene resin.

3. The sorbent as in claim 1, wherein the sorbent has a grafted chain length of 5.6-25.

4. The sorbent as in claim 1, further comprising a thermoplastic polymer binder, wherein the sorbent may be dispersed in the binder.

5. A method for CO₂ capture from aqueous environments comprising:
providing a sorbent comprising a support resin and a plurality of polyethyleneimine branches, the sorbent having a nitrogen content of 5-30% by weight and a particle size of 400-50 mesh, and
contacting an aqueous stream containing dissolved CO₂, carbonic acid, bicarbonate, or carbonate ions to be removed with the sorbent,
wherein the sorbent is formed by the steps comprising:
providing the support resin and a cyclic imino ether-containing monomer compound, and
grafting the cyclic imino ether-containing monomer compound off the support resin using a grafting-from technique.

6. The method as in claim 5, wherein support resin is a chloromethylated polystyrene resin.

7. The method as in claim 5, wherein the sorbent does not comprise primary, tertiary, or quaternary amines.

8. The method as in claim 5, wherein the cyclic imino ether-containing monomer compound is 2-oxazolines or 5,6-dihydro-4H-1,3-oxazines.

9. The method as in claim 5, wherein the sorbent has a bicarbonate uptake of up to 3.5 mmol/g.

10. The method as in claim 5, wherein the sorbent has a grafted-from chain length of 3.5-25.

11. The method as in claim 5, wherein the sorbent has a post-grafting chlorine content of less than 1%.

12. A method for CO₂ capture from gaseous environments comprising:
providing a sorbent, the sorbent comprising a porous support resin and a plurality of polyethyleneimine branches, the sorbent having a surface area of 25-250 m²/g, a nitrogen content of 5-20% by weight, a pore volume of 0.25-0.7 cm³/g, and
contacting a gaseous stream containing CO₂ to be removed with the sorbent,
wherein the sorbent is formed by the steps comprising:
providing the porous support resin and a cyclic imino ether-containing monomer compound, and
grafting the cyclic imino ether-containing monomer compound off the support resin using a grafting-from technique.

13. The method as in claim 12, wherein the gaseous stream contains more than 400 ppm CO₂ and the method further comprising removing more than 10% mol CO₂ per mol nitrogen in the sorbent.

14. The method as in claim 12, wherein the gaseous stream contains 4% CO₂ and the method further comprising removing 10-30% mol CO₂ per mol nitrogen in the sorbent.

15. The method as in claim 12, wherein the cyclic imino ether-containing monomer compound is 2-oxazolines or 5,6-dihydro-4H-1,3-oxazines.

16. The method as in claim 12, wherein the sorbent is regenerable.

17. The method as in claim 12, wherein the porous support resin is made of at least one monomer, the at least one monomer being vinylbenzylchloride, styrene, divinylbenzene or a combination thereof.

18. The method as in claim 12, wherein the sorbent is a polyalkylenimine polymer.

19. The method as in claim 12, wherein the sorbent does not comprise primary, tertiary, or quaternary amines.

20. The method as in claim 12, wherein the sorbent has a post-grafting chlorine content of 1-3.5%.

21. The method as in claim 12, wherein the sorbent has a post-grafting mmol nitrogen to surface area ratio of 0.025-0.25.
